(19) United States
(12) Patent Application Publication
(10) Pub. No.: US 2026/0321060 A1
(43) Pub. Date: Oct. 15, 2026

(54) COMPUTATION DEVICE OF DETECTING SCRATCHING BEHAVIOR FOR MICE AND METHOD THEREOF

(71) Applicants: National Yang Ming Chiao Tung University, Hsinchu City (TW); Kaohsiung Chang Gung Memorial Hospital, Kaohsiung City (TW)

(72) Inventors: Shin-Mu TSENG, Hsinchu City (TW); Chih-Hung LEE, Kaohsiung City (TW)

(21) Appl. No.: 19/258,921

(22) Filed: Jul. 3, 2025

(30) Foreign Application Priority Data
Apr. 14, 2025 (TW) 114114085

(51) Int. Cl. G06V 40/20; G06V 10/40; G06V 10/82; G06V 40/10

(52) U.S. Cl. CPC G06V 40/20; G06V 10/40; G06V 10/82; G06V 40/10

(57) ABSTRACT

A computation method of detecting scratching behavior for mice includes inputting multiple frames of a video to an artificial neural network model to obtain a scratching condition of each frame, and treating the frame having the scratching condition being positive as a scratching frame; computing a section-frame quantity of a frame section from a starting frame to a current frame and a scratching-frame quantity of the scratching frames within the frame section; determining a scratching event of the frame section according to a ratio between the scratching-frame quantity and the section-frame quantity; and computing a total scratching quantity of the scratching behavior of mice based on the scratching event detected in the video.

### CROSS-REFERENCE TO RELATED APPLICATION

This application claims priority to and the benefit of Taiwan Application Serial Number 114114085, filed on Apr. 14, 2025, the entire content of which is incorporated herein by reference as if fully set forth below in its entirety and for all applicable purposes.

### BACKGROUND

### Field of Disclosure

The disclosure generally relates to a computation device and a computation method, and more particularly, to a computation device and a computation method of detecting scratching behavior for mice.

### Description of Related Art

Nowadays, behavior models of laboratory mice are built to explore the neuro, skin, or other similar pathological phenomena in biological or medical science research. One of the behavior aspects that researchers often focus on is the scratching behavior of laboratory mice. For example, laboratory mice scratch due to itchiness or pain, and the scratching times vary based on the physiological condition. After the laboratory mice are given the drug testing, the difference in the scratching times helps the researchers find out the pathological improvement caused by the testing drug on the specific research issue.

To obtain the scratching times of the laboratory mice, counting the scratching manually or detecting the scratching by image detection are the primary practices. However, the manual counting practice is time-consuming, and the counting standard varies for different researchers; the image detection saves time. However the image detection mechanism is hard to bring the accurate scratching times of the laboratory mice, and it results in the problem of worse accuracy of the detection result.

Accordingly, improving the accuracy of detecting the scratching times of the laboratory mice is an issue worthy of focus.

### SUMMARY

The disclosure can be more fully understood by reading the following detailed description of the embodiments, with reference made to the accompanying drawings as described below. It should be noted that the features in the drawings are not necessarily to scale. In fact, the dimensions of the features may be arbitrarily increased or decreased for clarity of discussion.

The present disclosure of an embodiment provides a computation device of detecting scratching behavior for mice including a storage and a processor. The storage is configured to store a video comprising multiple frames, an artificial neural network model, and multiple program codes. The processor is connected with the storage and configured to execute the multiple program codes to perform operations of: inputting the multiple frames to the artificial neural network model, determining a scratching condition of each of the multiple frames by the artificial neural network model, and treating the frame having the scratching condition being positive as a scratching frame; computing a section-frame quantity of a frame section from a starting frame to a current frame and a scratching-frame quantity of the scratching frames within the frame section, wherein the starting frame is first of N consecutive frames of the scratching frame within the scratching frames and the current frame is the frame currently determined, N is a positive integer; determining a scratching event of the frame section according to a ratio between the scratching-frame quantity and the section-frame quantity; and computing a total scratching quantity of the scratching behavior of mice based on the scratching event detected in the video.

The present disclosure of another embodiment provides a computation method of detecting scratching behavior for mice, performed by a computation device. The computation method includes steps of: inputting multiple frames of a video to an artificial neural network model, determining a scratching condition of each of the multiple frames by the artificial neural network model, and treating the frame having the scratching condition being positive as a scratching frame; computing a section-frame quantity of a frame section from a starting frame to a current frame and a scratching-frame quantity of the scratching frames within the frame section, wherein the starting frame is first of N consecutive frames of the scratching frame within the scratching frames and the current frame is the frame currently determined, N is a positive integer; determining a scratching event of the frame section according to a ratio between the scratching-frame quantity and the section-frame quantity; and computing a total scratching quantity of the scratching behavior of mice based on the scratching event detected in the video.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference made to the accompanying drawings as described below. It should be noted that the features in the drawings are not necessarily to scale. In fact, the dimensions of the features may be arbitrarily increased or decreased for clarity of discussion.

FIG. 1 is a block diagram of a computation device of detecting scratching behavior for mice according to one embodiment of the disclosure.

FIG. 2 is a schematic diagram illustrating the detection of the scratching behavior for mice by multiple frames in a video according to one embodiment of the disclosure.

FIG. 3 is a flowchart of a computation method of detecting scratching behavior for mice according to one embodiment of the disclosure.

FIG. 4 is a schematic diagram illustrating the training result of estimating the artificial neural network model by a sample video according to one embodiment of the disclosure.

FIG. 5 is a flowchart of a computation method of detecting scratching behavior for mice according to another embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The specification provides various embodiments to facilitate the implementation of different features of the disclosure. The following descriptions of components and arrangements are illustrated as some aspects of implementations of the disclosure to prevent replication. It should be noted that the embodiments are exemplary and should not be limited herein. For example, technical terms such as “first” and “second” used herein to describe components are merely for distinguishing among the similar to identical elements or operations. The terminology is not intended to limit the technical features of the disclosure, nor to indicate any particular order or priority of operations or steps.

The element symbols or alphabets can be used repeatedly in each embodiment of the disclosure, though, the repeated symbols and alphabets are provided for simplicity and clarity, and they should not be interpreted to limit the relation of the technical terms, nor the order of operations among the embodiments.

The components of the disclosure are described as being “connected”, “coupled”, or “linked”, such terms may refer to electrical connections, electrical coupling, or communicative links. The terms “connected”, “coupled”, or “linked” may also interpret cooperative operations or interactions between or among components.

The technical term “module” indicates programs with algorithms executed by hardware computing components. A module may be a software module including multiple instructions and program codes or a functional module performing operations with a processor. Furthermore, the present disclosure does not limit the connection relationships among modules. Any mechanism among modules, through which a module may obtain necessary data or signals from other modules to perform its operations.

To facilitate understanding of the disclosure, the environment of detecting the scratching behavior of mice is that one laboratory mouse (herein referred to as a mouse or mice) is bred in one animal cage. In one embodiment, a camera is configured to film the animal cage. The camera is disposed at the position almost above the animal cage, so the camera lens shoots the animal cage and captures a top-view image containing of movement of the four limbs of the mouse without any blind angle.

In one embodiment, the user may arrange four animal cages in a square, so the camera may shoot the frame covering the four animal cages (i.e., each quadrant of the square of the frame covering one mouse). Before performing the detection of the scratching behavior of the mice, four blocks of the frame covering four animal cages are split into four frame segmentations, and each one of the frame segmentations covers one mouse. When the detection of the scratching behavior for mice is performed, the four frame segmentations are respectively detected. The counting of the scratching times depends on the detection result of the frame segmentation at the same quadrant to obtain the scratching behavior of the same mouse. In the embodiment, one video (covers four mice) is split into four frame segmentations for the behavior detections to obtain the scratching behavior of the four mice respectively. Therefore, the user may capture frames covering multiple mice with one camera to save the hardware cost and, at the same time, to perform the detection of the scratching behavior of multiple mice, and a high-efficiency detection environment is built.

For the sake of brevity, the embodiment below is one frame covering one mouse or one frame segmentation covering one mouse after splitting the frame.

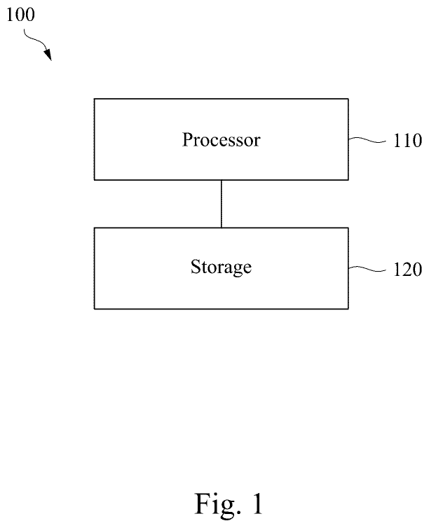

FIG. 1 is a block diagram of a computation device of detecting scratching behavior for mice according to one embodiment of the disclosure.

As shown in FIG. 1, the computation device 100 of scratching behavior for mice includes a processor 110 and a storage 120. The processor 110 is coupled to the storage 120.

In one embodiment, the storage 120 is configured to store videos to detect the scratching behavior, an artificial neural network model for detecting the scratching behavior of the mice, and multiple program codes.

In one embodiment, the processor 110 is configured to perform the artificial neural network model and the multiple program codes to execute the computation of the scratching behavior to obtain the scratching condition of all frames in the video.

In one embodiment, the artificial neural network model is the pre-trained model. In practice, after the artificial neural network model receives the video and performs the model computation, the artificial neural network model outputs a detection result of each frame of the video (e.g., when the scratching condition is ‘Yes’ or ‘positive’, the mouse in the frame has scratching behavior; when the scratching condition is ‘No’ or ‘negative’, the mouse in the frame does not have scratching behavior) and a confidence value of the detection result.

The artificial neural network model may be but is not limited to the object detection algorithm (such as You Only Look Once and its every version; YOLOv4, YOLOv7, or other version is optionally selected first), the Deformable Transformers (such as Deformable DETR). The detailed description may refer to the document: Zhu et al. (2021). Deformable DETR: Deformable Transformers for End-to-End Object Detection.

Based on the physiological mechanism, the scratching behavior of mice presents randomly. Furthermore, once the mouse scratches, the scratching behavior may continue for several seconds or present intermittently. In some situations, the algorithm regards the intermittent scratching as one scratching; in another embodiment, the algorithm determines one scratching depending on the total number of frames being detected the scratching behavior. However, the determination cannot reflect that the scratching behavior of the mouse is caused by the same or continuous neural signals or intermittent neural signals, so an accurate detection result cannot be obtained.

To improve the accuracy of the detection result, the processor 110 of the computation device 100 performs the operations below to achieve accurate detection.

In one embodiment, the processor 110 inputs a video containing a pending scratching behavior to the artificial neural network model, so the artificial neural network model determines the scratching condition of each of the multiple frames of the video. If the scratching condition is positive, it indicates that the frame has the scratching behavior; if the scratching condition is negative, it indicates that the frame does not have the scratching behavior.

The processor 110 treats the frame having positive scratching condition as a scratching frame according to the detection result of each frame. Accordingly, the processor 110 obtains a timestamp of the frame tagged as the scratching frame in the video.

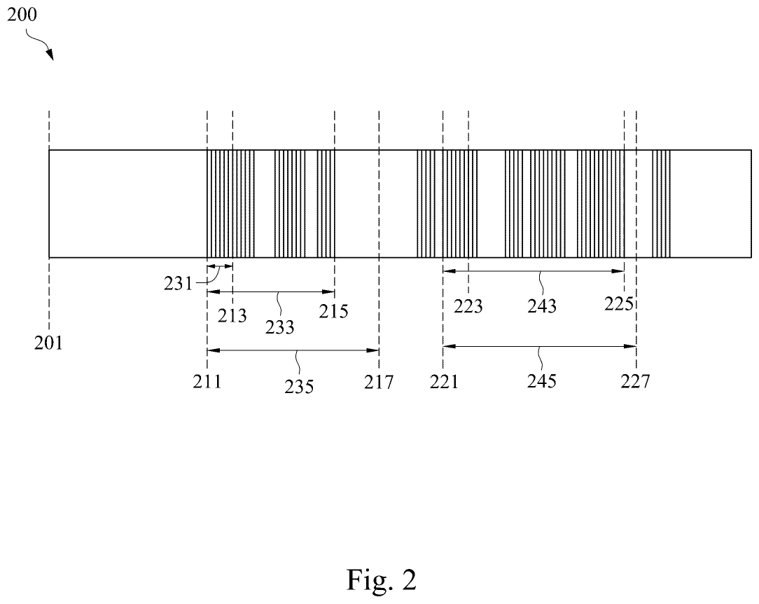

Reference is made to FIG. 2. FIG. 2 is a schematic diagram illustrating the detection of the scratching behavior for mice by multiple frames in a video according to one embodiment of the disclosure.

As shown in FIG. 2, after the computation of the artificial neural network model is performed, the video 200 is tagged with multiple scratching frames. The straight line of the video 200 indicates that the scratching condition is positive, that is, the position of the frame tagged as the scratching frame.

The processor 110 determines the scratching condition frame by frame by the time series and determines whether the situation of continuous or consecutive multiple frames being the scratching frame arises.

In one embodiment, the processor 110 uses a current frame to indicate the position of currently locating. For example, the processor 110 uses the current frame to detect the frames based on the time series from the frame 201 (or called a starting frame) to the frame 211. In FIG. 2, the embodiment shows the scratching condition changing from negative to positive at the position of the frame 211. At this time, the frame 211 is used as the starting frame, that is, the processor 110 sets the frame as the starting frame when the scratching condition changes from negative to positive.

In one embodiment, when the processor 110 determines N consecutive scratching frames present (by using the current frame based on the time series frame by frame), a confirmation process of a scratching event is activated.

In the confirmation process of the scratching event, a first frame of N consecutive scratching frames (N is a positive integer) is treated as the starting frame. The processor 110 computes a section-frame quantity of a frame section from the starting frame to the current frame, and computes a scratching-frame quantity of the scratching frames in the frame section.

For example, when the current frame is the frame 213 (i.e., the 5-th frame from the frame 211), the processor 110 computes that the section-frame quantity of the frame section 231 from the starting frame 211 to the current frame (i.e., the frame 213) is 5 frames, and also computes that the scratching-frame quantity of the frame section 231 is 5 frames. After several times computation with shifting the current frame, when the current frame is at the position of the frame 215 (i.e., the 23-rd frame from the frame 211), the processor 110 computes that section-frame quantity of the frame section 233 from the starting frame 211 to the current frame (i.e., the frame 215) is 23 frames, and also computes that the scratching-frame quantity of the frame section 231 is 17 frames. After several times computation with shifting the current frame, when the current frame is at the position of the frame 217 (i.e., the 33-rd frame from the frame 211), the processor 110 computes that section-frame quantity of the frame section 235 from the starting frame 211 to the current frame (the frame 217) is 33 frames, and also computes that the scratching-frame quantity of the frame section 231 is 17 frames.

Next, the processor 110 computes a ratio between the scratching-frame quantity and the section-frame quantity to confirm the scratching event of the frame section. The processor 110 computes a total scratching quantity of the scratching behavior of mice according to the scratching event detected in the video.

For example, when the current frame is at the position of the frame 213, the ratio between the scratching-frame quantity and the section-frame quantity is 1 (i.e., 5/5). When the current frame is at the position of the frame 215, the ratio between the scratching-frame quantity and the section-frame quantity is 0.73 (i.e., 17/23). When the current frame is at the position of the frame 217, the ratio between the scratching-frame quantity and the section-frame quantity is 0.51 (i.e., 17/33).

In one embodiment, the processor 110 computes the ratio between the scratching-frame quantity and the section-frame quantity. When the ratio is greater than a scratching threshold, the current frame is shifted to next frame, so the processor 110 computes the scratching-frame quantity of the frame section from the starting frame to the current frame and computes the ratio between the scratching-frame quantity and the section-frame quantity until the ratio is not greater than the scratching threshold. When the ratio is not greater than the scratching threshold, the processor 110 treats the scratching frame last detected of the frame section as a terminating frame, and sets the frame section from the starting frame to the terminating frame as one scratching event.

For example, the scratching threshold is 0.52. As shown in FIG. 2, when the current frame is located one frame before the frame 217, the ratio between the scratching-frame quantity and the section-frame quantity is 0.53 (i.e., 17/32). Because the ratio is 0.53, greater than the scratching threshold, the current frame is shifted to the position of the frame 217. However, the ratio when the current frame is located at the frame 217 is 0.51, not greater than the scratching threshold. At the present time, the processor 110 treats the scratching frame last detected in the frame section 235, i.e., the frame 215, as the terminating frame, and sets the frame section 233 from the frame 211 to the frame 215 as one scratching event. In other words, 17 frames are detected with the scratching behavior and 23 frames are detected without the scratching behavior in the scratching event, and the scratching event presents within the frame section 233 of the video 200.

The processor 110 continuously detects the next frame of the video until the video finishes. For example, in the following frame from the frame 217, the processor 110 keeps performing the operations mentioned above. To prevent redundant examples, in the embodiment, the processor 110 detects another scratching event by the operations mentioned above, and the frame 221 is the starting frame. The confirmation process of the scratching event is activated at the position of the frame 223, and the ratio that is smaller than the scratching threshold presents at the position of the frame 227. The last frame detected as the scratching frame within the frame section 245, i.e., the frame 225, is treated as the terminating frame, and the processor 110 sets the frame section 243 from the frame 221 to the frame 225 as another scratching event. In other words, the processor 110 detects two scratching events in the video 200, the frame section 233 and the frame section 243 respectively. Therefore, the total scratching quantity computed by the processor 110 is twice.

In one embodiment, the computation device 100 further includes a graphical user interface. The graphical user interface is configured to display the scratching condition of the video 200 along with the time series. For example, the representation of the scratching condition may be the straight lines shown in FIG. 2 or colored lines (not shown in figures) such as the yellow lines indicating the frames with scratching behavior and the purple lines indicating the frames without scratching behavior.

In another embodiment, the video 200 in the timeline may be zoomed in or zoomed out on the graphical user interface. The patterns of the scratching condition displayed on the graphical user interface include different colors, and each color represents the scratching frequency of the multiple frames that are collapsed. For example, the video 200 is displayed on the graphical user interface with 5 frames collapsed into 1 frame. When all 5 frames are the scratching frames, the position of the collapsed frames is shown by the brighter yellow color.

The graphical user interface may be the interface provided by the web application, and the user can upload video through the browser or connect the camera to the interface. After the computation device 100 performs all the operations, the graphical user interface shows the final result.

In the above embodiment of one frame covers four animal cages, before detecting the scratching behavior of the mice, four blocks corresponding to the four animal cages in the frame are segmented into four frame segmentations. At this time, each of the frame segmentations is served as one video and inputted into the artificial neural network model, to compute the total scratching times for each video.

In another embodiment, the computation device 100 further includes a camera (not shown in figures). The camera is connected to the storage 120 and is configured to save the video to the storage 120 temporarily. The processor 120 may detect the scratching behavior of the mice in the video almost in real-time to compute the total scratching times.

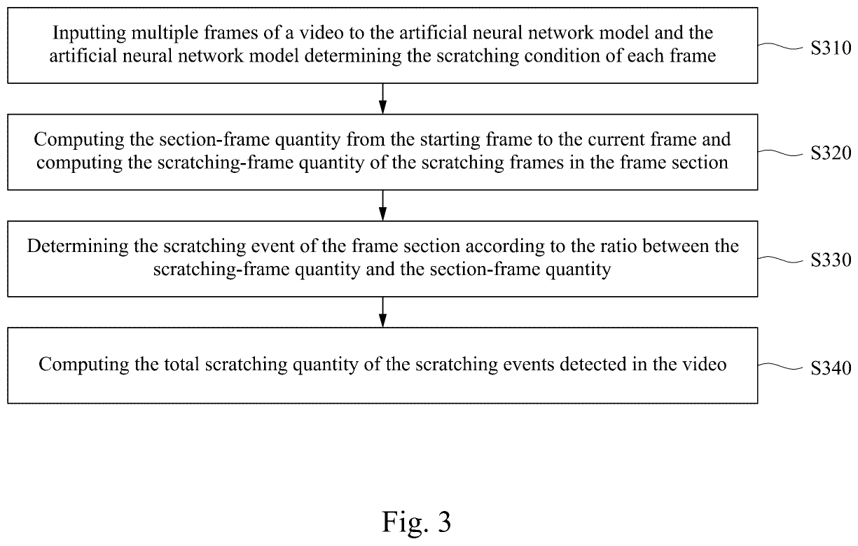

FIG. 3 is a flowchart of a computation method of detecting scratching behavior for mice according to one embodiment of the disclosure. The computation method of detecting scratching behavior for mice can be performed by the computation device 100 of FIG. 1.

In step S310, the processor 110 inputs multiple frames of a video to the artificial neural network model, and the artificial neural network model determines the scratching condition of each frame.

When the determination of the artificial neural network model is positive, it indicates that the mouse shown in the frame has the scratching behavior; when the determination of the artificial neural network model is negative, it indicates that the mouse shown in the frame does not have the scratching behavior.

In step S320, the processor 110 computes the section-frame quantity from the starting frame to the current frame and computes the scratching-frame quantity of the scratching frames in the frame section.

In one embodiment, the processor 110 tags the frame having a positive scratching condition (the scratching condition being positive) as the scratching frame according to the detection result of each frame, and computes the quantity of the frames that are tagged as the scratching frames in the video 200.

In step S330, the processor 110 determines the scratching event of the frame section according to the ratio between the scratching-frame quantity and the section-frame quantity.

The processor 110 determines the scratching condition frame by frame based on the time series. The frame that is currently determined by the processor 110 is called the current frame. The processor 110 determines the frames from the starting frame and shifts to the next frame after each determination is made.

In one embodiment, the current frame read by the processor 110 is the K-th frame from the starting frame, where K is a positive integer. The processor 110 counts the quantity (the scratching-frame quantity), denoted as S, of the frames that are tagged as the scratching frame to the K-th frame (the section-frame quantity), and computes the ratio S/K between the scratching-frame quantity S and the section-frame quantity K.

When the processor 110 determines that the ratio is greater than the scratching threshold, the current frame is shifted to the next frame, and then the processor 110 computes the ratio between the scratching-frame quantity and the section-frame quantity, where the scratching-frame quantity is the quantity of the frames tagged as the scratching frames counted from the starting frame to the current frame (i.e., the (K+1)-th frame), until the ratio between the scratching-frame quantity and the section-frame quantity is not greater than the threshold. When the processor 110 determines that the ratio is not greater than the scratching threshold, the last frame detected as the scratching frame in the frame section is treated as the terminating frame, and the frame section from the starting frame to the terminating frame is treated as one scratching event by the processor 110.

The processor 110 continuously detects the next frame of the video until the end of the video.

In step S340, the processor 110 computes the total scratching quantity of the scratching events detected in the video.

In one embodiment, the processor 110 in step S330 counts one scratching event as one scratching, so the total scratching quantity of all the detected scratching events detected in the video is obtained with the counting pattern.

To achieve the detection of the scratching behavior of mice to compute the correct scratching times mentioned above, before detection is performed, the computation device 100 uses multiple sample videos to train and test the artificial neural network model.

In one embodiment, the storage 120 is configured to store the multiple sample videos, such as the pre-recorded mouse videos.

The processor 110 pre-sets an actual scratching event of each sample video. The sample video is the video tagged with the actual scratching event of mice. The actual scratching event indicates the video being setting the scratching behavior of mice at multiple and continuous or consecutive frames within an actual scratching section. Each sample video is set with one or more actual scratching behavior according to the video content. For the sake of brevity, the following takes one sample video containing one actual scratching event as an example, but the disclosure is not limited to the quantity of the actual scratching events within each sample video.

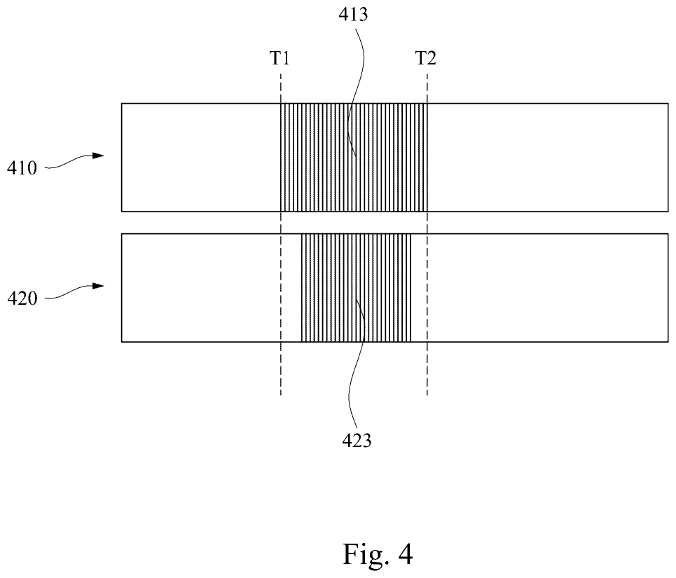

FIG. 4 is a schematic diagram illustrating the training result of estimating the artificial neural network model by a sample video according to one embodiment of the disclosure.

As shown in FIG. 4, the sample video 410 includes multiple sample frames (where the horizontal axis corresponds to the timeline and the vertical axis corresponds to one frame). The sample video 410 is pre-set with the actual scratching event, such as the actual scratching section between time T1 and T2. The actual scratching event with the scratching behavior of mice is tagged as the event frames 413, such as the frame, denoted by the straight lines in FIG. 4, tagged scratching.

In one embodiment, the processor 110 inputs the multiple sample frames of the sample video 410 to the artificial neural network model to output a testing result 420 of each sample frame, where the testing result 420 includes a confidence value of the testing result computed by the artificial neural network model.

In one embodiment, when the testing result 420 indicates scratching and the confidence value is greater than a standard value, the processor 110 tags the sample frame as a detected scratching frame 423, as the straight line shown in FIG. 4. The standard value may be a default value to estimate the confidence value of the testing result.

Furthermore, to estimate the performance of the artificial neural network model, the processor 110 computes the quantity of the scratching frames 423 detected and the quantity of the event frames 413 of the actual scratching event to obtain a detecting rate according to the actual scratching section, such as within time T1 to T2, tagged scratching in the scratching event. When the detecting rate is greater than a detection threshold, the processor 110 counts one time to the detected scratching quantity.

In one embodiment, the detecting rate may be the ratio between the quantity of the scratching frames 423 and the quantity of the event frames 413.

For example, the quantity of the event frames 413 in the actual scratching section is 58 frames, and the quantity of the scratching frames 413 is 45 frames, so the detecting rate is 0.78. Suppose that the detection threshold is 0.7, the processor 110 counts the detected scratching to one time.

It should be noted that the actual scratching section indicates frames within a specific time section in the sample video. In other words, the detecting rate is a reference value used to determine whether the artificial neural network model correctly detects the scratching condition in the same frame. That is, when the correct detection within the actual scratching section is higher than the detection threshold, the processor 110 counts the detection as one scratching.

In one embodiment, the processor 110 examines all the sample videos with the same testing rule to obtain the scratching quantity of all the sample videos to obtain the total scratching quantity. The processor 110 estimates the training result of the artificial neural network model based on the total scratching quantity.

In one embodiment, the processor 110 computes the ratio between the detected scratching quantity and the actual scratching base and determines whether the ratio is higher a sample threshold. When the ratio is greater than the sample threshold, it indicates that the quality of the artificial neural network model detecting the multiple sample video satisfies the requirement. Therefore, the processor 110 determines that the training result passes the validation criteria, and the artificial neural network model may be deployed on a practical field. On the contrary, the processor 110 continuously trains the artificial neural network model until the training result of the artificial neural network model satisfies the validation.

In one embodiment, the artificial neural network model outputs a detected scratching result (such as determining whether the frame involves scratching) of each sample frame of each sample video. Because the actual scratching section in the sample video is tagged in advance, the processor 110 has the position of the frame involving scratching. Therefore, the processor 110 may use the information on the actual scratching section to compare each frame with the output result of the artificial neural network model to obtain the actual prediction performance of the artificial neural network model. The actual prediction performance may be utilized as another parameter to estimate the training result of the artificial neural network model.

For example, there are 10 frames in a sample video, and the actual scratching condition is NNNYYYNYNN (where Y indicates the frame with scratching actually happening and N indicates the frame without scratching actually happening) in the time series. If the same sample video is inputted into the artificial neural network model, and the detected scratching result of the artificial neural network model is NNYYYYNNNN, the processor 110 gets the information that the detection error occurs at 2 frames (i.e., the 3-rd frame and the 8-th frame). That is, the actual prediction performance of the artificial neural network model is 0.8.

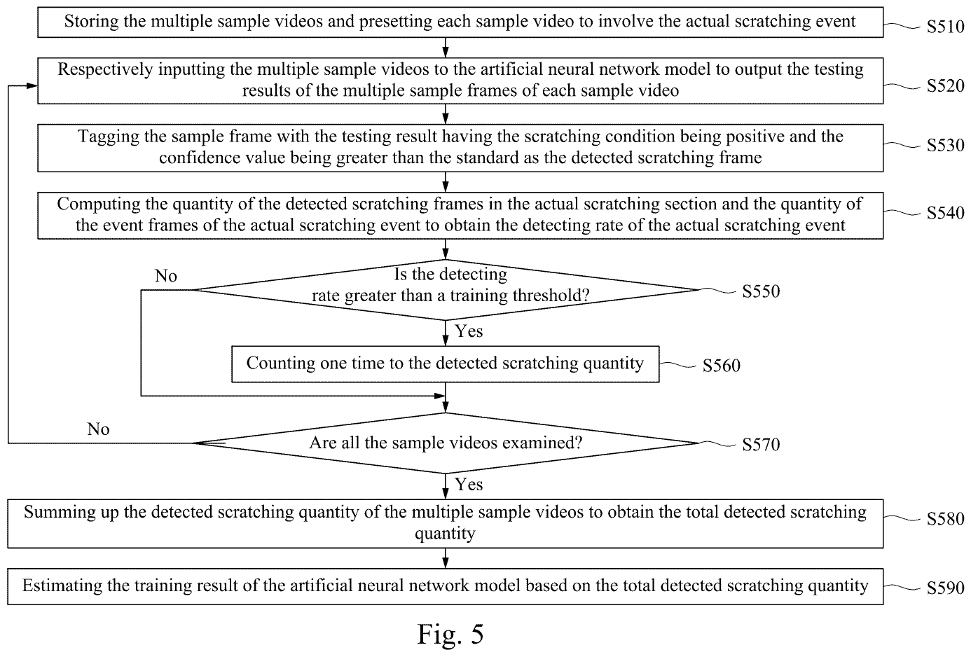

FIG. 5 is a flowchart of a computation method of detecting scratching behavior for mice according to another embodiment of the disclosure. The computation method of FIG. 5 may be performed by the computation device 100 of FIG. 1.

In step S510, the storage 120 stores the multiple sample videos and each sample video is preset to involve the actual scratching event.

In one embodiment, the actual scratching section of the actual scratching event may be the continuous or consecutive N frames with the preset tags of the scratching condition.

In step S520, the processor 110 respectively inputs the multiple sample videos to the artificial neural network model to output the testing results of the multiple sample frames of each sample video.

For example, the scratching condition of each sample frame of the sample video detected by the artificial neural network model is treated as the testing result, such as positive (scratching) or negative (no scratching).

In step S530, the processor 110 tags the sample frame with the testing result having the scratching result being positive and the confidence value being greater than the standard as the detected scratching frame.

In one embodiment, the processor 110 tags all the sample frames of the sample video to obtain the testing result of each sample frame.

In step S540, the processor 110 computes the quantity of the detected scratching frames in the actual scratching section and the quantity of the event frames of the actual scratching event to obtain the detecting rate of the actual scratching event.

In one embodiment, the actual scratching section is a known time section in the sample video, and the processor 110 utilizes the same time section to be the baseline for comparing the actual scratching event with the detected scratching event. For example, the actual scratching section is the 5-th to the 7-th second of the sample video, so the processor 110 computes the ratio between the quantity of the scratching frames in the detected scratching event and the quantity of the event frames in the actual scratching section based on the time section within the 5-th to the 7-th second, and the ratio is the detecting rate.

In step S550, the processor 110 determines whether the detecting rate is greater than a training threshold. If the determination is positive, the process proceeds to step S560; otherwise, the process proceeds to step S570.

In step S560, the processor 110 counts one time to the detected scratching quantity.

In one embodiment, when the correct detection of the actual scratching section is higher than the detection threshold, the processor 110 counts the correct detection as one scratching.

In step S570, the processor 110 determines whether all the sample videos are examined. If the determination is positive, the process proceeds to step S580; otherwise, the process goes back to step S520, inputting the remained sample video to the artificial neural network model to obtain the testing results of all the sample videos.

In step S580, the processor 110 sums up the detected scratching quantity of the multiple sample videos to obtain the total detected scratching quantity.

In step S590, the processor 110 estimates the training result of the artificial neural network model based on the total detected scratching quantity. If the training result is excellent (such as the processor 110 determines the ratio between the total detected scratching quantity and the actual scratching base is greater than the sample threshold), the artificial neural network model may be deployed on a practical field.

In one embodiment, the artificial neural network model may be trained by utilizing the k-fold cross-validation. For example, the multiple sample videos may be divided into 3 groups of videos, being utilized as the training videos, the validation videos, and the testing videos, respectively. Each sample video may be used as one of the training videos, the validation videos, and the testing videos at each fold of the cross validation. Therefore, the finite data may be effectively utilized to prevent the overfitting problem and improve the model generalization.

In one embodiment, the computation method may be implemented as a computer program, and the computer program is stored in a non-transitory computer-readable storage medium. The processor 110 is configured to read the computer program of the non-transitory computer-readable storage medium to perform the computation method of detecting the scratching behavior for mice.

In one embodiment, the processor 110 may be but is not limited to the microprocessor, the Digital Signal Processors (DSP), the Application Specific Integrated Circuit (ASIC), the central processing unit (CPU), the System on Chip (SoC), the Field Programmable Gate Array (FPGA), the network processor chip, or any combination of the elements above.

In one embodiment, the storage 120 may be but is not limited to the Random Access Memory (RAM), the Flash memory, the Read Only Memory (ROM), the Hard Disk Drive (HDD), the Solid State Drive (SSD), the optical storage, or any combination of the elements above.

Accordingly, the disclosure provides a computation device of detecting the scratching behavior for mice and the computation method of detecting the scratching behavior for mice, including operations and steps of detecting the scratching conditions of all the frames of the videos and flexibly estimating the scratching behavior of the mice by the scratching condition of the frames, to correctly compute the scratching times of the mice in the video. Compared to the related art, the disclosure provides the solution of miscounting the scratching times.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A computation device of detecting scratching behavior for mice, comprising:
a storage, configured to store a video comprising multiple frames, an artificial neural network model, and multiple program codes; and
a processor, connected with the storage and configured to execute the multiple program codes to perform operations of:
inputting the multiple frames to the artificial neural network model, determining a scratching condition of each of the multiple frames by the artificial neural network model, and treating the frame having the scratching condition being positive as a scratching frame;
computing a section-frame quantity of a frame section from a starting frame to a current frame and a scratching-frame quantity of the scratching frames within the frame section, wherein the starting frame is first of N consecutive frames of the scratching frame within the scratching frames and the current frame is the frame currently determined, N is a positive integer;
determining a scratching event of the frame section according to a ratio between the scratching-frame quantity and the section-frame quantity; and
computing a total scratching quantity of the scratching behavior of mice based on the scratching event detected in the video.

2. The computation device of claim 1, wherein the processor is configured to perform operations of:
shifting the current frame to next frame when the ratio is greater than a scratching threshold, and computing the ratio between the scratching-frame quantity and the section-frame quantity of the frame section from the starting frame to the current frame, until the ratio is not greater than the scratching threshold; and
treating the scratching frame last detected within the frame section as a terminating frame when the ratio is not greater than the scratching threshold, and treating the frame section from the starting frame to the terminating frame as once of the scratching event.

3. The computation device of claim 1, further comprising a graphical user interface, wherein the processor is configured to perform operations of:
displaying the scratching condition of the video in timeline on the graphical user interface.

4. The computation device of claim 3, wherein the scratching condition displayed on the graphical user interface comprises multiple different colors, each color showing a scratching frequency of the multiple frames being collapsed.

5. The computation device of claim 1, wherein the processor is configured to perform operations of:
storing multiple sample videos and presetting each of the multiple sample videos to involve an actual scratching event;
respectively inputting the multiple sample videos to the artificial neural network model to output a testing result of each of multiple sample frames of each of the multiple sample videos, wherein the testing result comprises a confidence value; and
tagging the sample frame having the testing result having the scratching condition being positive and the confidence value being greater than a standard value as a detected scratching frame within the multiple sample frames of each of the multiple sample videos.

6. The computation device of claim 5, wherein the processor is configured to perform operations of:
based on each of the multiple sample videos, computing a quantity of the detected scratching frame in the actual scratching section and a quantity of an event frame of the actual scratching event based on an actual scratching condition tagged as scratching in the actual scratching event, to obtain a detecting ratio of the multiple actual scratching events; and
counting a detected scratching quantity when the detecting ratio is greater than a detection threshold.

7. The computation device of claim 6, wherein the processor is configured to perform operations of:
summing up the detected scratching quantity of the multiple sample videos to obtain a total detected scratching quantity; and
estimating a training result of the artificial neural network model based on the total detected scratching quantity.

8. A computation method of detecting scratching behavior for mice, performed by a computation device, the computation method comprising:
inputting multiple frames of a video to an artificial neural network model, determining a scratching condition of each of the multiple frames by the artificial neural network model, and treating the frame having the scratching condition being positive as a scratching frame;
computing a section-frame quantity of a frame section from a starting frame to a current frame and a scratching-frame quantity of the scratching frames within the frame section, wherein the starting frame is first of N consecutive frames of the scratching frame within the scratching frames and the current frame is the frame currently determined, N is a positive integer;
determining a scratching event of the frame section according to a ratio between the scratching-frame quantity and the section-frame quantity; and
computing a total scratching quantity of the scratching behavior of mice based on the scratching event detected in the video.

9. The computation method of claim 8, wherein determining the scratching event of the frame section according to the ratio between the scratching-frame quantity and the section-frame quantity comprises:
shifting the current frame to next frame when the ratio is greater than a scratching threshold, and computing the ratio between the scratching-frame quantity and the section-frame quantity of the frame section from the starting frame to the current frame, until the ratio is not greater than the scratching threshold; and
treating the scratching frame last detected within the frame section as a terminating frame when the ratio is not greater than the scratching threshold, and treating the frame section from the starting frame to the terminating frame as once of the scratching event.

10. The computation method of claim 8, further comprising:
displaying the scratching condition of the video in timeline on a graphical user interface.

11. The computation method of claim 10, wherein displaying the scratching condition on the graphical user interface comprises:
displaying multiple different colors on the graphical user interface, each color showing a scratching frequency of the multiple frames being collapsed.

12. The computation method of claim 8, wherein before deploying the artificial neural network model on an actual application comprises:
storing multiple sample videos and presetting each of the multiple sample videos to involve an actual scratching event;
respectively inputting the multiple sample videos to the artificial neural network model to output a testing result of each of multiple sample frames of each of the multiple sample videos, wherein the testing result comprises a confidence value; and
tagging the sample frame having the testing result having a positive scratching condition and the confidence value being greater than a standard value as a detected scratching frame within the multiple sample frames of each of the multiple sample videos.

13. The computation method of claim 12, wherein after tagging the sample frame as the detected scratching frame comprises:
based on each of the multiple sample videos, computing a quantity of the detected scratching frame in the actual scratching section and a quantity of an event frame of the actual scratching event based on an actual scratching condition tagged as scratching in the actual scratching event, to obtain a detecting ratio of the multiple actual scratching events; and
counting a detected scratching quantity when the detecting ratio is greater than a detection threshold.

14. The computation method of claim 13, wherein after counting the detected scratching quantity comprises:
summing up the detected scratching quantity of the multiple sample videos to obtain a total detected scratching quantity; and
estimating a training result of the artificial neural network model based on the total detected scratching quantity.
